(19) United States
(12) Patent Application Publication
(10) Pub. No.: US 2018/0207464 A1
(43) Pub. Date: Jul. 26, 2018

(54) TRAINING SYSTEM FOR HIGH JUMP IMPROVEMENT

(71) Applicant: Ryan Long, Benton, MO (US)

(72) Inventor: Ryan Long, Benton, MO (US)

(21) Appl. No.: 15/412,279

(22) Filed: Jan. 23, 2017

(51) Int. Cl. A63B 5/16; A63B 69/00; G09B 19/00

(52) U.S. Cl. CPC A63B 5/16; A63B 2225/093; G09B 19/0038; A63B 69/00

(57) ABSTRACT

A training system for high jump performance that includes a landing platform with adjustable legs supporting the landing platform, where the adjustable legs are adapted to vary the height of the landing platform. A trainer places the landing platform in a high jump training environment and engages an athlete in a series of jump attempts, where the height of the landing platform is adjusted to provide for increased performance by the athlete. Preferably, the adjustable legs include a support brace and each leg rests on a footing.

### BACKGROUND OF THE INVENTION

### Field of Invention

The present invention relates to the training system used to improve the performance of the high jumpers.

### Description of Related Art

Track and field includes various sporting events involving running, jumping and throwing contests. As everyone is familiar many of the track and field events are performed yearly and enjoyed by participants at all levels. Many of the track and field events require athletes to harness their skills for competition. The training involves many hours and dedication to increase performance levels. One particular track and field event includes the high jump, where this event requires an athlete to approach a bar and catapult over the bar at various heights. It is important to maintain consistent height over the bar in order to complete the jump. High jump participants must keep stand tall and float their bodies above the maximum height of the bar in order to ensure a successful jump. The float of the jumper's body is important in that they must keep the float and arch er to get over the bar successfully. The present invention provides a complete training system and implements a platform as a practice prop to encourage proper form for the high jumper.

### SUMMARY OF THE INVENTION

The present invention relates to a training system for high jump performance that includes a landing platform with adjustable legs supporting the landing platform, where the adjustable legs are adapted to vary the height of the landing platform. A trainer places the landing platform in a high jump training environment and engages an athlete in a series of jump attempts, where the height of the landing platform is adjusted to provide for increased performance by the athlete. Preferably, the adjustable legs include a support brace and each leg rests on a footing.

The training system provides a method of high jump performance training that includes the steps of: placing a landing platform at a predetermined height; engaging a series of jump attempts, where the user attempts to land on the landing platform; increasing the height incrementally during the series of jump attempts; monitoring the user performance and technique during the series of jump attempts; and continuing repetition of the steps to increase overall user performance. The method according to claim 3, where the step of increasing the height is accomplish in three inch intervals.

### BRIEF DESCRIPTION OF DRAWINGS

FIG. 1 depicts a landing platform that is used in conjunction with the present invention.

### DETAILED DESCRIPTION

The present invention relates to a training system for high jump performance that includes a landing platform with adjustable legs to support the platform. The platform adjusts in height and provides a substitute for the high bar during training. The platform allows the jumper to elevate their bodies and ensure that they maintain the height in order to sit on the platform at the height of the jump. The platform includes the adjustable legs, which may be incremented at various heights to help high jumpers achieve the improved performance in high jumping.

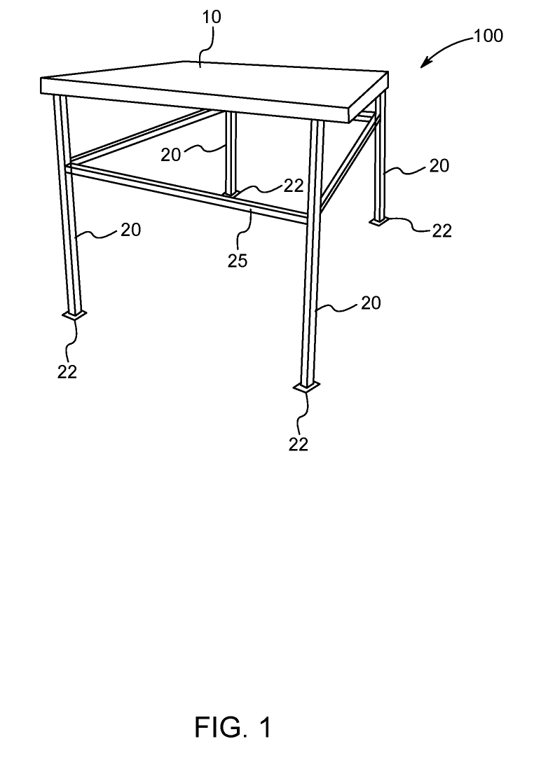

In reference to FIG. 1, a high jump training platform 100 is depicted. The training platform 100 includes a landing surface 10 supported on legs 20. A leg 20 is provided at each corner of the platform 100, which is substantially rectangular in shape. A brace 25 adjoins between each leg 20 to provide further support of the landing platform 100. Under each leg 20 is a footing 22 that supports these legs 20 in an upright position.

The present invention utilizes the landing platform 100 to help in improving high jump performance. An athlete goes through a series of jumps using the landing platform 100, a trainer may adjust the height as the performance of the athlete increases over time. The landing platform 100 may be incremented in height during the series of jump attempts, where the athlete maintains the floating aspect of the jump to sit on the platform at the height of the jump.

Through the use of this training system a high jump athlete is able to maintain a tall, upright position and float the remaining portion of the body to reach maximum height over a high bar without the fear of falling or breaking the bar while using the platform. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A training system for high jump performance comprising:
a. a landing platform;
b. adjustable legs supporting the landing platform, where the adjustable legs are adapted to vary the height of the landing platform;
c. placement of the landing platform in a high jump training environment; and
d. engagement of a series of jump attempts by a user, where the height of the landing platform is adjusted to provide for increased performance for the user.

2. The training system according to claim 1, where the adjustable legs include a support brace.

3. The training system according to claim 1, where each adjustable leg includes a footing.

4. A method of high jump performance training comprising the steps of:
a. placing a landing platform at a predetermined height;
b. engaging a series of jump attempts, where the user attempts to land on the landing platform;
c. increasing the height incrementally during the series of jump attempts;
d. monitoring the user performance and technique during the series of jump attempts; and
e. continuing repetition of steps b-d to increase overall user performance.

5. The method according to claim 3, where the step of increasing the height is accomplish in three inch intervals.
